(19) United States
(12) Patent Application Publication
(10) Pub. No.: US 2026/0238113 A1
(43) Pub. Date: Aug. 13, 2026

(54) STACKED OUTPUT DRIVER SWITCHING POWER SUPPLY WITH ACTIVE CLAMPING AND SELECTIVE BYPASS OF PRE-CHARGE CIRCUITS

(71) Applicant: CIRRUS LOGIC INTERNATIONAL SEMICONDUCTOR LTD., Edinburgh (GB)

(72) Inventors: Shashank Alevoor, Chandler, AZ (US); Pietro Gallina, Chandler, AZ (US); Jithender Tirunahari, Chandler, AZ (US)

(21) Appl. No.: 19/050,901

(22) Filed: Feb. 11, 2025

(51) Int. Cl. H02M 1/08; H02M 1/00; H02M 1/32; H02M 3/335

(52) U.S. Cl. CPC H02M 1/08; H02M 1/0032; H02M 1/32; H02M 3/33569; H02M 1/0006

(57) ABSTRACT

Stacked output driver power converters circuits having output drivers arranged in a stacked multi-level configuration may be operated in a discontinuous mode while preserving adequate voltage levels on the pre-driver power supply capacitors. Power supply connections of pre-driver circuits that operate the output drivers are supplied with operating voltage from a floating rail circuit and a return to the output terminal of the output driver. A control circuit selects between a full-power operating state of the switching power supply circuit and a low-power pulsed operating state. At least two active clamp circuits provide corresponding return current paths for current from the pre-driver circuits when the low-power pulsed operating mode is selected, so that the output drivers do not block return currents from the at least one pre-driver circuit when they are turned off during discontinuous operation.

### BACKGROUND

### 1. Field of Disclosure

The field of representative embodiments of this disclosure relates to stacked output driver switching power supply circuits, and in particular to a stacked output driver circuit including actively clamped and/or selectively bypassed pre-charge circuits.

### 2. Background

Switched-power conversion circuits are commonly used in implementing power management integrated circuit (PMIC) power supplies due to high power efficiency and reduced magnetic component weight and size. In order to provide efficiency under different conditions in which high output current is required and quiescent conditions in which very low output current is required, mode switching in switching power converters has been applied. In particular, switching between a pulsed operating mode, in which only enough current is injected into the resonant output filter of the power supply to maintain the output voltage and to satisfy any quiescent current requirement, and a continuous operating mode, in which the power converter is continuously switched, have long been implemented.

Stacked output driver architecture may be used to implement multi-level switching power converters. In particular, multi-level buck converters using a stacked output driver architecture are desirable for implementing PMICs in battery-operated circuits, as the power converter can be reconfigured to operate with voltages both greater than the required output voltage and less than the required output voltage. By implementing a multi-phase control and selectively connecting a flyback capacitor between power supply rails, and also selectively connecting the flyback capacitor to the output inductor, smaller inductors and lower-voltage capacitors may be used to achieve a required level of output current ripple, while yielding a higher power conversion efficiency.

However, controlling such a stacked output driver architecture during low-power discontinuous operation presents several problems. The pre-driver circuit power supply voltages in the stacked driver architecture are typically generated by a bootstrap arrangement that generates the power supply voltages from the switching action of the power converter, refreshing charge on the pre-driver power supply capacitors as the converter is switched. In discontinuous operation, the voltage on the pre-driver power supply capacitors may droop, causing improper levels at the inputs of the output drivers when output driver switching re-commences. While a separate reference circuit may be used to charge the pre-driver power supply capacitors, the off-state condition of the output driver stack blocks all of the return paths for the charging current, which can cause the body diode of the output driver transistors to conduct, limiting the voltage to which the pre-driver power supply capacitors can be charged.

Therefore, it would be advantageous to provide a stacked output driver power converter that may be operated in a discontinuous mode while preserving adequate voltage levels on the pre-driver power supply capacitors.

### SUMMARY

Stacked output driver power converters that may be operated in a discontinuous mode while preserving adequate voltage levels on the pre-driver power supply capacitors are accomplished in switching power supply circuits and their methods of operation.

The switching power supply circuits include a plurality of output drivers arranged in a stacked multi-level configuration, a plurality of pre-driver circuits corresponding to the plurality of output drivers that have outputs driving inputs of the output drivers. Power supply connections of the plurality of pre-driver circuits are supplied with operating voltage from a floating rail circuit and a return to the output terminal of the corresponding output driver. The switching power supply circuits also include a control circuit for selecting between a full-power operating state of the switching power supply circuit and a low-power pulsed operating state and at least two active clamp circuits that provide corresponding return current paths for current from a corresponding at least one of the pre-driver circuits when the low-power pulsed operating mode is selected, so that an off-state of the plurality of output drivers does not block return currents from the at least one pre-driver circuit.

The summary above is provided for brief explanation and does not restrict the scope of the claims. The description below sets forth example embodiments according to this disclosure. Further embodiments and implementations will be apparent to those having ordinary skill in the art. Persons having ordinary skill in the art will recognize that various equivalent techniques may be applied in lieu of, or in conjunction with, the embodiments discussed below, and all such equivalents are encompassed by the present disclosure.

### BRIEF DESCRIPTION OF THE DRAWINGS

FIG. 1 is a block diagram illustrating an example power management integrated circuit (PMIC) 10, in accordance with an embodiment of the disclosure.

FIG. 2 is a simplified schematic diagram illustrating details of an example switched-mode power supply (SMPS) circuit 20, which may be used to implement circuits within example PMIC 10 of FIG. 1, in accordance with an embodiment of the disclosure.

FIGS. 3A-3C are simplified schematic diagrams illustrating operating conditions within example SMPS circuit 20 of FIG. 2, in accordance with an embodiment of the disclosure.

FIG. 4 is a schematic diagram illustrating an example SMPS circuit 20A, which may be used to implement SMPS 20 of FIG. 2, in accordance with an embodiment of the disclosure.

FIG. 5A is a schematic diagram illustrating an example floating reference circuit 50A, which may be used to implement SMPS circuit 20A of FIG. 4, in accordance with an embodiment of the disclosure.

FIG. 5B is a schematic diagram illustrating another example floating reference circuit 50B, which may be used to implement SMPS circuit 20A of FIG. 4, in accordance with another embodiment of the disclosure.

FIG. 6 is a schematic diagram illustrating a bypass control circuit 60 that may be used to operate bypass transistors P24-P26 of floating reference circuit 50A and 50B of FIG. 5A and FIG. 5B, respectively, in accordance with embodiments of the disclosure.

### DETAILED DESCRIPTION OF ILLUSTRATIVE EMBODIMENT

The present disclosure encompasses circuits and integrated circuits that include switching power supply circuits having output drivers arranged in a stacked multi-level configuration. Power supply connections of pre-driver circuits that operate the output drivers are supplied with operating voltage from a floating rail circuit and a return to the output terminal of the output driver. A control circuit selects between a full-power operating state of the switching power supply circuit and a low-power pulsed operating state. At least two active clamp circuits provide corresponding return current paths for current from the pre-driver circuits when the low-power pulsed operating mode is selected, so that the output drivers do not block return currents from the at least one pre-driver circuit when they are turned off during discontinuous operation.

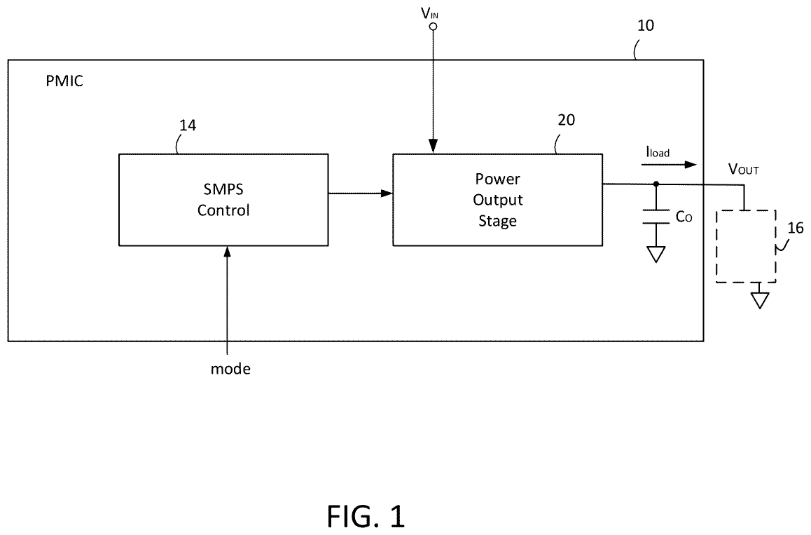

Referring now to FIG. 1, a block diagram of an example power management integrated circuit (PMIC) 10 is shown, in accordance with an embodiment of the disclosure. A switched-mode power supply (SMPS) control block 14 provides switching control signals to a power output stage 20 that generates a power output according to an implemented switching topology. Power output stage 20 is coupled to an output capacitor C_{O} that filters the output of power output stage 20, which is provided to a system 16 being power-managed by PMIC. A voltage feedback loop, which alternatively may be a current feedback loop when an output current I_{load} is controlled, rather than an output voltage V_{O}, supplies a feedback signal to SMPS control block 14 to control the switching control signals provided to power output stage 20. Power output stage 20 receives energy from a power source, which in the example embodiment is an input voltage V_{IN}, which may be, for example, a battery, a rectified and filtered AC power source, or other suitable power supply. SMPS control block 14 provides multiple operating modes, in order to provide efficiency at both low and high levels of output current I_{load}. In particular, SMPS control block 14 may operate power output stage 20 in a selectable pulse-width modulation (PWM) mode and a pulse-frequency modulation (PFM) mode. While the above description and various embodiments illustrated herein are directed to a switched-mode power supply (SMPS), it is understood that the techniques disclosed herein may be used in other power conversion systems, such as Class-D amplifiers.

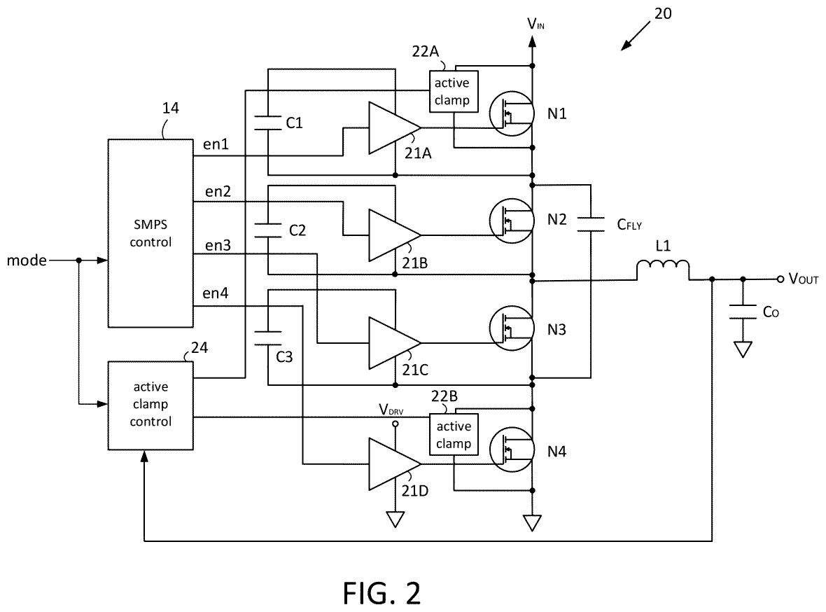

Referring now to FIG. 2, a simplified schematic diagram illustrating details of an example switched-mode power supply (SMPS) circuit 20, which may be used to implement circuits within example PMIC 10 of FIG. 1 is shown, in accordance with an embodiment of the disclosure. SMPS control block 14 generates switch enable signals en1-en4, which enable the four output driver transistors N1-N4, respectively, through respective pre-driver circuits 21A-21D in order to operate output driver transistors N1-N4 in sequence to generate the switching patterns required to operate SMPS circuit 20 as a multi-level buck converter when control signal mode selects a full-power continuous switching mode. When output power is not required, e.g., when the load being supplied is in a power-down or standby state, switch enable signals en1-en4 are only asserted as much as necessary to maintain the nominal output voltage value on output capacitor C_{O}. Output driver transistors N2 and N3 selectively couple an inductor L1 that filters the switched-power signals along with output capacitor C_{O}, to either terminal of a flyback capacitor C_{FLY}, that in turn is selectively charged/discharged by connecting the other terminal of flyback capacitor C_{FLY} to input voltage V_{IN} by activating output driver transistor N1 or to ground by activating output driver transistor N4. Pre-driver circuits 21A-21C are provided with operating current from a series of floating power supply rails that include respective holding capacitors C1-C3. Holding capacitors C1-C3 are charged by a boost scheme that refreshes the holding capacitor voltages during continuous operation of SMPS circuit 20. During continuous operation, the switching of output driver transistors N1-N3 provide transient currents that change the states of the gates of output driver transistors N1-N3, which refreshes the boosted floating power supply rail voltages held by holding capacitors C1-C3.

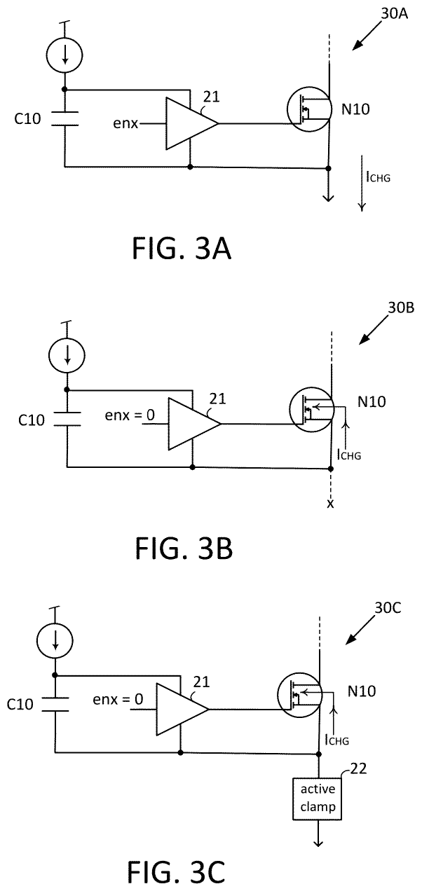

However, when SMPS circuit 20 is operated discontinuously, i.e., in a low-power operating mode, the refresh scheme that maintains the floating power supply rail voltages is interrupted, and further, there is no conduction path for the return power supply connections of pre-driver circuits 21A-21C, since output driver transistors N1-N3 are generally maintained in an off state, during low-power operation. Referring additionally to FIGS. 3A-3C, simplified schematic diagrams illustrate operating conditions within example SMPS circuit 20 of FIG. 2, in accordance with an embodiment of the disclosure. Transistor N10 is illustrative of one of output driver transistors N1-N3 that has an output conduction current I_{CHG}, which, as shown in FIG. 3A, when a stacked device or device chain connected to the source of transistor N10 is conducting, is allowed to flow, and as the state of input signal enx at the input of a pre-driver circuit 21 changes, a voltage stored on holding capacitor C10 is refreshed from a current source I1. However, as shown in FIG. 3B, when input signal enx is in a low-voltage state, e.g., ground, and the stacked device or device chain connected to the source of transistor N10 is disabled and therefore not conducting, the only return path for output conduction current I_{CHG} is through the body diode of transistor N10, which causes a reduction in the voltage provided by the refresh scheme, since the return terminal of pre-driver circuit 21 will rise to the forward voltage drop of the body diode of transistor N10 when that conduction path is active. FIG. 3C illustrates a solution to the problem, in accordance with an embodiment of the disclosure, in which an active clamp circuit 22 is included to provide an alternative path for the return current. As illustrated by SMPS circuit 20 of FIG. 2, an active clamp circuit 22A is included to provide an alternative conduction path to the conduction path through the body diode of transistor N1 that could otherwise deplete the floating power supply rail voltages. Similarly, an active clamp circuit 22B provides an alternative conduction path to the conduction path through the body diode of transistor N4. An active clamp control block 24 controls whether or not active clamps 22A, 22B are enabled. Only one of active clamps 22A, 22B is activated based on the value of output voltage V_{O} during discontinuous operation, so that when, for example, output voltage V_{O}>input voltage V_{IN}/2, active clamp 22A is activated, as the conduction path through the body diode of transistor N1 needs to be bypassed, and when output voltage V_{O}<input voltage V_{IN}/2, active clamp 22A is activated, as the conduction path through the body diode of transistor N4 needs to be bypassed.

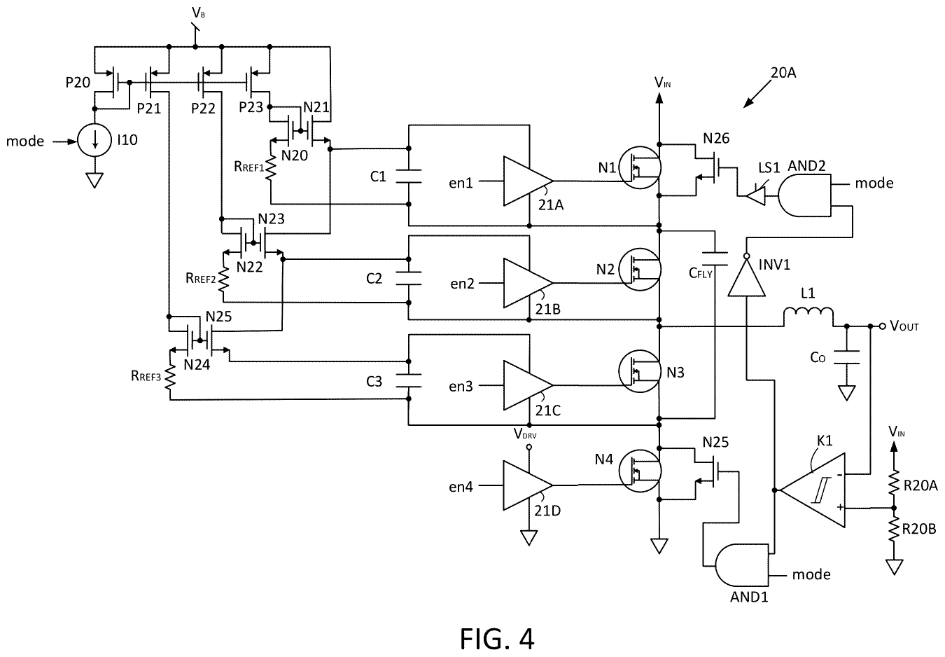

Referring now to FIG. 4, a schematic diagram illustrating an example SMPS circuit 20A, which may be used to implement SMPS 20 of FIG. 2 is shown, in accordance with an embodiment of the disclosure. The output driver and pre-driver circuits of SMPS circuit 20A are the same as those shown and described with reference to FIG. 2 above, so only differences between the figures will be described in detail below. Holding capacitors C1-C3 are charged from a reference circuit that receives a boosted input voltage V_{B}, which in the example embodiment, has a voltage equal to input voltage V_{IN} plus a voltage V_{DRV}, which is the non-boosted drive voltage level supplied to pre-driver circuit 21D. A current source I10 is coupled to a current mirror formed by transistor P20 and a plurality of mirror transistors P21, P22 and P23 that supply charge to maintain the floating power supply rails provided to pre-driver circuits 21A-21C. A source follower circuit formed by transistors N20, N21 supplies a voltage set by resistor R_{REF1}, which is applied across holding capacitor C1 to supply a floating power supply rail voltage to pre-driver 21A. Similarly, other source follower circuits formed by transistor pair N22, N23 and transistor pair N24, N25 apply voltages across holding capacitors C2 and C3, as set by resistor R_{REF2} and resistor R_{REF3}, respectively. Current source I10 may be disabled according to control signal mode when SMPS 20A is in continuous switching mode, and enabled in discontinuous switching mode to replace the refresh of holding capacitors C1, C2 and C3, which as described above, may otherwise be unable to maintain the floating power supply rail voltages required by pre-driver circuits 21A-21C. Active clamp circuits 22A and 22B in SMPS 20 of FIG. 2 are implemented in SMPS 20A by transistors N26 and N25, respectively. A hysteresis comparator K1 compares output voltage V_{O} with a reference voltage generated from input voltage V_{IN} by resistors R20A and R20B, and logic implemented by logical-AND gates AND1 and AND2, along with inverter INV1, selects which of active clamp 22A or active clamp 22B to activate when control signal mode indicates that SMPS circuit 20 is operating in the discontinuous low-power switching mode. Only one of transistors N25, N26 is turned on based on the value of output voltage V_{O} during discontinuous operation, so that when, for example, output voltage V_{O}>input voltage V_{IN}/2, the output of comparator K1 is in a logical “0” state and the output of inverter INV1 is in a logical “1” state, so that the output of logical-AND gate AND2 is in a logical “1” state when control signal mode is also in a logical “1” state, indicating that SMPS circuit 20A is in a discontinuous low power operating mode. Similarly, logical-AND gate AND1 only turns on transistor N26 when V_{O}<input voltage V_{IN}/2 and SMPS circuit 20A is in a discontinuous low power operating mode. Level shifter LS1 provides a level shift to ensure that transistor N26 can be turned on. Alternatively, transistor N26 may be replaced with a P-channel device and logical-AND gate AND2 replaced with a logical-NAND operation.

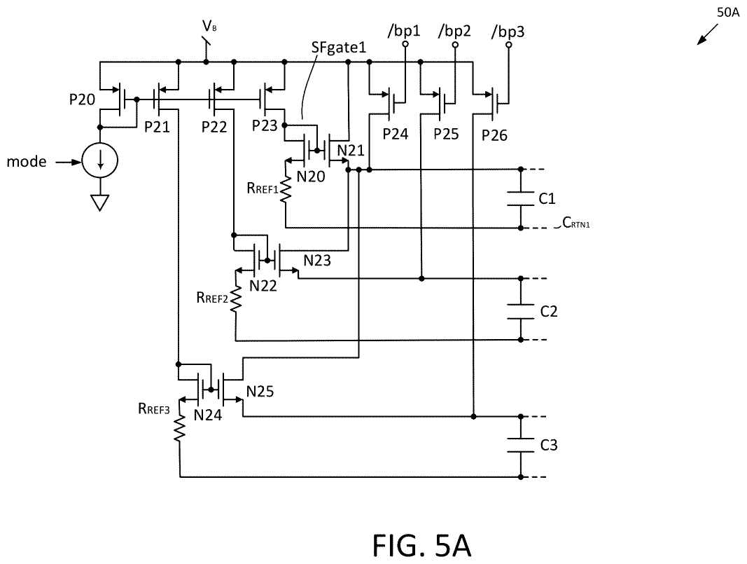

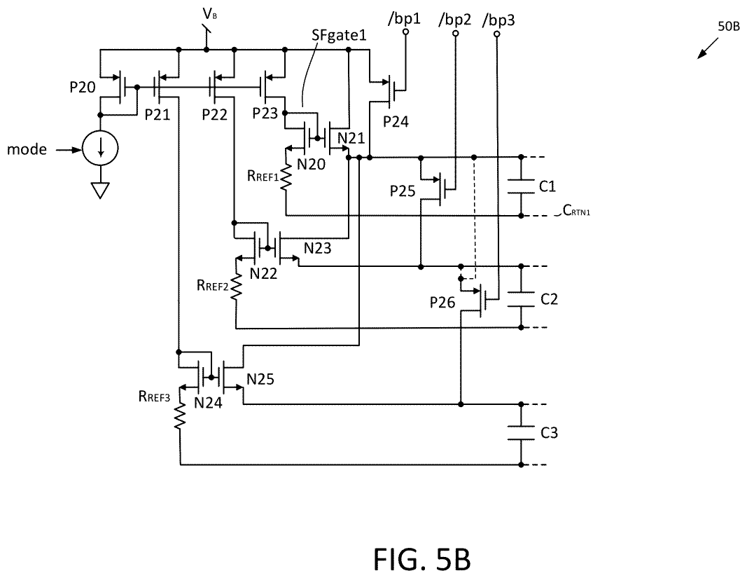

While SMPS circuit 20A maintains the loss of conduction paths for the return terminals of pre-drivers 21A-21C through the activation of the active clamps provided by transistors N25,N26, under low power supply voltage conditions, the source follower circuits formed by transistors N20-N25 may draw excessive current from the reference, i.e., the current mirror formed with transistor P20 and the corresponding one of transistors P21-P23. Under such conditions, the floating power supply rail voltages on holding capacitors C1-C3 will droop. To prevent the floating power supply rail voltages on holding capacitors C1-C3 from drooping, a source-follower bypass device may be included. Referring now to FIG. 5A, a schematic diagram illustrating an example floating reference circuit 50A, which may be used to implement SMPS circuit 20A of FIG. 4, is shown in accordance with an embodiment of the disclosure. Floating reference circuit 50A is similar to corresponding portions of SMPS circuit 20A of FIG. 4, so only differences between them will be described in further detail below. Bypass transistors P24, P25, and P26 have channels coupled between boosted input voltage V_{B} and a corresponding one of holding capacitors C1-C3, and are activated by corresponding control signals /bp1, /bp2, and/bp3, generated by control circuits described in further detail below. The control circuits detect the above-described voltage droop condition(s) occurring on holding capacitors C1-C3, and activate one or more of control signals /pby1, /pby2 and/pby3, while the droop condition(s) exist, which, in turn, activate corresponding one(s) of bypass transistors P24, P25, and P26 to charge one or more of holding capacitors C1-C3. The drains of bypass transistors P24, P25, and P26 are connected to boosted input voltage V_{B} in the depicted embodiment, but alternative schemes may also be employed.

Referring now to FIG. 5B, a schematic diagram illustrating another example floating reference circuit 50B, which may be used to implement SMPS circuit 20A of FIG. 4, is shown in accordance with another embodiment of the disclosure. Floating reference circuit 50B is similar to floating reference circuit 50A of FIG. 5A, so only differences between them will be described in further detail below. Instead of bypass transistors P24, P25, and P26 having channels coupled between boosted input voltage V_{B} and the corresponding floating power supply rail terminal of holding capacitors C1-C3, the drain terminals of bypass transistors P24, P25, and P26 are coupled to the next-higher-voltage one of the floating power supply rails, or in the case of transistor P24, which is connected to the highest voltage floating power supply rail, the drain terminal is connected to boosted input voltage V_{B} as in floating reference circuit 50A of FIG. 5A. Alternatively, the drain terminal of any of bypass transistors P24, P25, and P26 may be connected to a higher one of the floating power supply rails, as exemplified by the dashed line connection from the drain of transistor P26 to the same floating power supply rails as the drain of transistor P25 instead of the corresponding floating power supply rail at the common connection between holding capacitors C1 and C2.

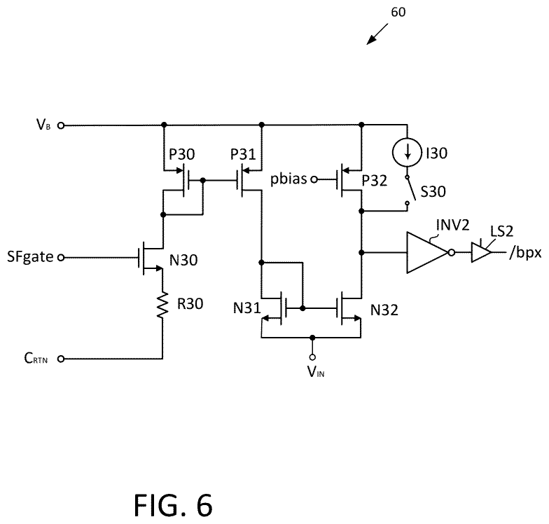

Referring now to FIG. 6, a schematic diagram illustrating a bypass control circuit 60 that may be used to operate bypass transistors P24-P26 of floating reference circuits 50A and 50B of FIG. 5A and FIG. 5B, respectively, in accordance with embodiments of the disclosure. A separate bypass control circuit is provided to implement each of control signals /bp1, /bp2 and /bp3 in FIG. 5A and FIG. 5B, represented by control signal/bpx in bypass control circuit 60 of FIG. 6. Control signal/bpx is activated in response to detecting a reduction in reference current in the respective one of the source followers implemented by transistor pair N20, N21, transistor pair N22, N23, and/or transistor pair N24, N25 in FIG. 5A and FIG. 5B. The common gate connection of the corresponding source follower transistor pair is provided to control circuit 60 as input signal SFgate, which, along with a resistor R30, which is referenced to the return terminal of the corresponding one of holding capacitors C1-C3 in floating reference circuits 50A and 50B of FIG. 5A and FIG. 5B. Transistor N30 sets a current level in a transistor P30, which is then mirrored by a transistor P31, which in turn is mirrored by a transistor N31, accomplishing a shift of reference to input voltage V_{IN}. Transistor N31 forms a current mirror with a transistor N32. A transistor P32 receives a bias reference signal pbias and is connected in series with transistor N32, so that when the current level in the corresponding source follower transistor pair falls, due to reduced power supply levels, the input to an inverter INV2 rises in voltage, and generates a logical “0” output from inverter INV2, which is level-shifted by a level shifter LS2 and provided to the gate of the corresponding one of the bypass transistors P24-P26, which act to overcome the droop in the corresponding floating power supply rail by bypassing the corresponding respective one of the source followers implemented by transistor pair N21, N22, transistor pair N22, N23, and transistor pair N24, N25.

In summary, this disclosure shows and describes circuits and integrated circuits implementing switching power supply circuits. The switching power supply circuits may include a plurality of output drivers arranged in a stacked multi-level configuration, and a plurality of pre-driver circuits corresponding to the plurality of output drivers that have outputs driving inputs of the output drivers. Power supply connections of the plurality of pre-driver circuits may be supplied with operating voltage from a floating rail circuit and a return to the output terminal of the corresponding output driver. The switching power supply circuits may also include a control circuit for selecting between a full-power operating state of the switching power supply circuit and a low-power pulsed operating state, and at least two active clamp circuits that provide corresponding return current paths for current from a corresponding at least one of the pre-driver circuits when the low-power pulsed operating mode is selected. An off-state of the plurality of output drivers that does not block return currents from the at least one pre-driver circuit may be provided thereby.

In some example embodiments, the at least two active clamp circuits may include multiple active clamp circuits corresponding to ones of the plurality of pre-driver circuits, and may operate such that only one of the multiple active clamp circuits is activated at a time. The activated clamp circuit may be selected in dependence on an output voltage of the switching power supply circuit.

In some example embodiments, at least one of the plurality of pre-driver circuits may include a source follower circuit that is selectively bypassed according to a control input. In some example embodiments, the circuit may include a voltage comparator that compares an output voltage of the source follower circuit to a reference voltage to generate the control input, so that the source follower circuit is bypassed when the output voltage of the source follower circuit is less than the reference voltage. In some example embodiments. a current comparison circuit may be included, and the current comparison circuit may compare a current consumed by the floating rail circuit to a reference current level to generate the control input, so that the source follower circuit is bypassed when the current consumed by the floating rail circuit is less than the reference current.

In some example embodiments, the at least two active clamp circuits may include multiple active clamp circuits each corresponding to a unique one of the pre-driver circuits. In some example embodiments, the at least two active clamp circuits may include a first number of multiple active clamp circuits one less than a second number of the pre-driver circuits, and each of the multiple active clamp circuits may correspond to a unique one of the pre-driver circuits other than a particular one of the multiple pre-driver that provides an output to the input of a corresponding one of the output drivers that provides an output of the switching power supply circuit. In some example embodiments, the at least two active clamp circuits may be coupled between a corresponding one of the output drivers and a substrate or one or more wells surrounding one or more devices that form the corresponding output drivers.

In some example embodiments, the plurality of output drivers may implement the stacked multi-level configuration by a drain of a first transistor implementing a first one of the plurality of output drivers being connected to a power supply rail, and subsequent drains of next transistors implementing the plurality of output drivers may be connected to source terminals of previous ones of the plurality of output drivers, and a source of a last transistor implementing a last one of the plurality of output drivers may be connected to a power supply return rail, and outputs of the pre-driver circuits may be coupled to gates of the transistors implementing the corresponding output drivers. In some example embodiments, the floating rail circuit may be a current mirror having a plurality of mirror output arms each coupled to a power supply input of a corresponding one of the plurality of pre-driver circuits, and a power supply return of the corresponding pre-driver circuit may be coupled to a source terminal of the transistor implementing the corresponding one of the plurality of output drivers.

While the disclosure has shown and described particular embodiments of the techniques disclosed herein, it will be understood by those skilled in the art that the foregoing and other changes in form, and details may be made therein without departing from the spirit and scope of the disclosure. For example, the techniques shown above may be applied to another circuit or system having a stacked driver output stage, such as a motor controller or audio amplifier.

What is claimed is:

1. A switching power supply circuit, comprising:
a plurality of output drivers arranged in a stacked multi-level configuration;
a plurality of pre-driver circuits corresponding to the plurality of output drivers that have outputs driving inputs of the output drivers, wherein power supply connections of the plurality of pre-driver circuits are supplied with operating voltage from a floating rail circuit and a return to the output terminal of the corresponding output driver;
a control circuit for selecting between a full-power operating state of the switching power supply circuit and a low-power pulsed operating state; and
at least two active clamp circuits that provide corresponding return current paths for current from a corresponding at least one of the pre-driver circuits when the low-power pulsed operating mode is selected, whereby an off-state of the plurality of output drivers does not block return currents from the at least one pre-driver circuit.

2. The switching power supply circuit of claim 1, wherein the at least two active clamp circuits comprises multiple active clamp circuits corresponding to ones of the plurality of pre-driver circuits, wherein only one of the multiple active clamp circuits is activated, wherein the activated one of the multiple active clamp circuits is selected in dependence on an output voltage of the switching power supply circuit.

3. The switching power supply circuit of claim 1, wherein at least one of the plurality of pre-driver circuits includes a source follower circuit that is selectively bypassed according to a control input.

4. The switching power supply circuit of claim 3, further comprising a voltage comparator that compares an output voltage of the source follower circuit to a reference voltage to generate the control input, whereby the source follower circuit is bypassed when the output voltage of the source follower circuit is less than the reference voltage.

5. The switching power supply circuit of claim 3, further comprising a current comparison circuit that compares a current consumed by the floating rail circuit to a reference current level to generate the control input, whereby the source follower circuit is bypassed when the current consumed by the floating rail circuit is less than the reference current.

6. The switching power supply circuit of claim 1, wherein the at least two active clamp circuits comprises multiple active clamp circuits each corresponding to a unique one of the pre-driver circuits.

7. The switching power supply circuit of claim 1, wherein the at least two active clamp circuits comprises a first number of multiple active clamp circuits one less than a second number of the pre-driver circuits, each of the multiple active clamp circuits corresponding to a unique one of the pre-driver circuits other than a particular one of the multiple pre-driver that provides an output to the input of a corresponding one of the output drivers that provides an output of the switching power supply circuit.

8. The switching power supply circuit of claim 1, wherein the at least two active clamp circuits are coupled between a corresponding one of the output drivers and a substrate or one or more wells surrounding one or more devices that form the corresponding output drivers.

9. The switching power supply circuit of claim 1, wherein the plurality of output drivers implement the stacked multi-level configuration by a drain of a first transistor implementing a first one of the plurality of output drivers being connected to a power supply rail, and subsequent drains of next transistors implementing the plurality of output drivers being connected to source terminals of previous ones of the plurality of output drivers, and a source of a last transistor implementing a last one of the plurality of output drivers being connected to a power supply return rail, wherein outputs of the pre-driver circuits are coupled to gates of the transistors implementing the corresponding output drivers.

10. The switching power supply circuit of claim 9, wherein the floating rail circuit is a current mirror having a plurality of mirror output arms each coupled to a power supply input of a corresponding one of the plurality of pre-driver circuits, and wherein a power supply return of the corresponding pre-driver circuit is coupled to a source terminal of the transistor implementing the corresponding one of the plurality of output drivers.

11. A method of operating a switching power supply circuit, the method comprising:
providing one or more switching power supply output signals from a plurality of output drivers arranged in a stacked multi-level configuration;
driving inputs of the output drivers with a corresponding plurality of pre-driver circuits;
supplying power supply connections of the plurality of pre-driver circuits with operating voltage from a floating rail circuit and with a return to the output terminal of the corresponding output driver;
selecting between a full-power operating state of the switching power supply circuit and a low-power pulsed operating state; and
responsive to selection of the low-power pulsed operating stage, activating at least one of multiple active clamp circuits that provide corresponding return current paths for current from a corresponding at least one of the pre-driver circuits, whereby an off-state of the plurality of output drivers does not block return currents from the at least one pre-driver circuit.

12. The method of claim 11, wherein only one of the multiple active clamp circuits is activated responsive to selection of the low-power pulsed operating state in dependence on an output voltage of the switching power supply circuit.

13. The method of claim 11, wherein at least one of the plurality of pre-driver circuits includes a source follower circuit, and wherein the method further comprises selectively bypassing the source follower circuit responsive to a control input.

14. The method of claim 13, further comprising comparing an output voltage of the source follower circuit to a reference voltage to generate the control input, whereby the source follower circuit is bypassed when the output voltage of the source follower circuit is less than the reference voltage.

15. The method of claim 13, further comprising comparing a current consumed by the floating rail circuit to a reference current level to generate the control input, whereby the source follower circuit is bypassed when the current consumed by the floating rail circuit is less than the reference current.

16. The method of claim 11, wherein the at least two active clamp circuits comprises multiple active clamp circuits each corresponding to a unique one of the pre-driver circuits.

17. The method of claim 11, wherein the at least two active clamp circuits comprises a first number of multiple active clamp circuits one less than a second number of the pre-driver circuits, each of the multiple active clamp circuits corresponding to a unique one of the pre-driver circuits other than a particular one of the multiple pre-driver that provides an output to the input of a corresponding one of the output drivers that provides an output of the switching power supply circuit.

18. The method of claim 11, wherein the at least two active clamp circuits are coupled between a corresponding one of the output drivers and a substrate or one or more wells surrounding one or more devices that form the corresponding output drivers.

19. The method of claim 18, wherein the plurality of output drivers implement the stacked multi-level configuration by a drain of a first transistor implementing a first one of the plurality of output drivers being connected to a power supply rail, and subsequent drains of next transistors implementing the plurality of output drivers being connected to source terminals of previous ones of the plurality of output drivers, and a source of a last transistor implementing a last one of the plurality of output drivers being connected to a power supply return rail, wherein outputs of the pre-driver circuits are coupled to gates of the transistors implementing the corresponding output drivers.

20. The method of claim 19, wherein the floating rail circuit is a current mirror having a plurality of mirror output arms each coupled to a power supply input of a corresponding one of the plurality of pre-driver circuits, and wherein a power supply return of the corresponding pre-driver circuit is coupled to a source terminal of the transistor implementing the corresponding one of the plurality of output drivers.
